(19) United States
(12) Patent Application Publication
(10) Pub. No.: US 2025/0300283 A1
(43) Pub. Date: Sep. 25, 2025

(54) BATTERY PACK WIRING HARNESS SEAL STRUCTURE

(71) Applicant: FCA US LLC, Auburn Hills, MI (US)

(72) Inventors: Tuanjie Li, Shanghai (CN); Xinjie Liu, Shanghai (CN); Xiaoping Mao, Shanghai (CN)

(21) Appl. No.: 18/609,289

(22) Filed: Mar. 19, 2024

(51) Int. Cl. H01M 50/186; H01M 50/105; H01M 50/193

(52) U.S. Cl. CPC H01M 50/186; H01M 50/105; H01M 50/193; H01M 2220/20

(57) ABSTRACT

A sealing structure for an aperture formed in a housing of a battery pack including a first pipe positioned in the aperture, a second pipe connected to the first pipe, a sealant provided in at least the second pipe that provides a hermetic seal of the aperture, and a first clamp attached to the second pipe in a manner that radially narrows a diameter of second pipe to restrict movement of the sealant to maintain the hermetic seal during increases in pressure of the housing.

### FIELD

The present disclosure relates to a battery pack wiring harness seal structure.

### BACKGROUND

This section provides background information related to the present disclosure which is not necessarily prior art.

As the development of electrically powered vehicles increases, the development of the structure of the battery pack housing the battery cells is also increasing. In this regard, when new battery packs are being developed, it is necessary to conduct thermal and pressure testing of the battery pack under various operating conditions. In order to conduct the thermal and pressure testing, various sensors may be located in the battery pack to generate various signals indicative of temperature and pressure under the various operating conditions.

The temperature and pressure sensors are electrically connected to, for example, various monitoring devices that receive the signals generated by the sensors by wires. It is necessary, therefore, for the battery pack to have an aperture formed therein that permits the wires to extend between the sensors and the monitoring devices. If the aperture is not properly sealed during the thermal and pressure testing of the battery pack, however, the signals generated by sensors may not be accurate. Accordingly, there is a need for a wiring harness seal structure that satisfactorily seals the aperture and enables accurate signals to be generated by the sensors during the thermal and pressure testing of the battery pack.

### SUMMARY

This section provides a general summary of the disclosure, and is not a comprehensive disclosure of its full scope or all of its features.

According to a first aspect of the present disclosure there is provided a sealing structure for an aperture formed in a housing of a battery pack having at least one sensor positioned therein. The aperture is configured to permit a wire attached to the at least one sensor to exit the housing. The sealing structure includes a first pipe positioned in the aperture and including a first end, an opposite second end, and a first passage extending between the first end and the second end through which the wire extends from the housing, the first end having a radially outwardly extending flange configured to abut an interior surface of the housing; a second pipe having a proximate end connected to the opposite second end of the first pipe, a distal end, and a second passage extending between the proximate end and the distal end through which the wire extends from the first passage; a sealant provided in at least the second pipe that provides a hermetic seal of the aperture; and a first clamp attached to the distal end of the second pipe in a manner that radially narrows a diameter of second pipe to restrict movement of the sealant to maintain the hermetic seal during increases in pressure of the housing.

According to the first aspect, the sealant is formed of a material that undergoes room temperature vulcanization.

According to the first aspect, the material includes a silicone material.

According to the first aspect, the sealing structure may further include an annular gasket between the radially outwardly extending flange and the interior surface of the housing.

According to the first aspect, the annular gasket is formed of an elastomeric material that is configured to be compressed between the radially outwardly extending flange and the interior surface of the housing.

According to the first aspect, an outer surface of the second end of the first pipe includes a threading.

According to the first aspect, the sealing structure may further include a threaded nut that is mated with the threading of the second end of the first pipe between an exterior surface of the housing and the proximate end of the second pipe.

According to the first aspect, the sealing structure may further include a second clamp that secures the proximate end of the second pipe to the opposite second end of the first pipe.

According to the first aspect, the second pipe is formed of a flexible polymeric material.

According to a second aspect of the present disclosure, there is provided a method for sealing a wiring conduit attached to a battery pack that includes passing a first pipe of the wiring conduit through an aperture formed in the battery pack; fixing the first pipe to the battery pack; attaching a second pipe of the wiring conduit to the first pipe; injecting a viscous sealant into at least the second pipe attached to the first pipe; attaching a clamp to the second pipe including the viscous sealant to radially narrow a diameter of the second pipe; and curing the viscous sealant to hermetically seal the wiring conduit, wherein the clamp that radially narrows the diameter of the second pipe restricts movement of the cured sealant to maintain the hermetic seal during increases in pressure of the battery pack.

According to the second aspect, the first pipe includes a radially outwardly extending flange configured to abut an interior surface of the housing, and the step of passing the first pipe of the wiring conduit through the aperture includes a step of placing an annular gasket between the radially outwardly extending flange and the interior surface.

According to the second aspect, the annular gasket is formed of an elastomeric material that is configured to be compressed between the radially outwardly extending flange and the interior surface of the housing.

According to the second aspect, the sealant is formed of a material that undergoes room temperature vulcanization.

According to the second aspect, the material includes a silicone material.

According to the second aspect, an outer surface of the first pipe includes a threading, and the step of fixing the first pipe to the battery pack includes mating a threaded nut with the threading of the first pipe.

According to the second aspect, the step of attaching the second pipe of the wiring conduit to the first pipe includes attaching a second clamp to the second pipe to secure the second pipe to the first pipe.

According to the second aspect, the second pipe is formed of a flexible polymeric material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example battery pack;

FIG. 2 is a schematic cross-sectional view of the example battery pack illustrated in FIG. 1 having a wiring harness sealing structure according to a principle of the present disclosure; and

FIG. 3 is an enlarged schematic cross-sectional view of the wiring harness sealing structure according to a principle of the present disclosure, with the sealant being omitted.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

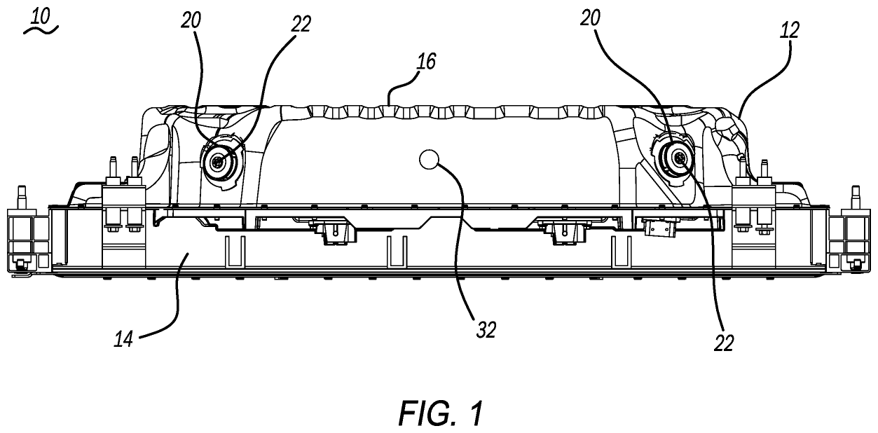

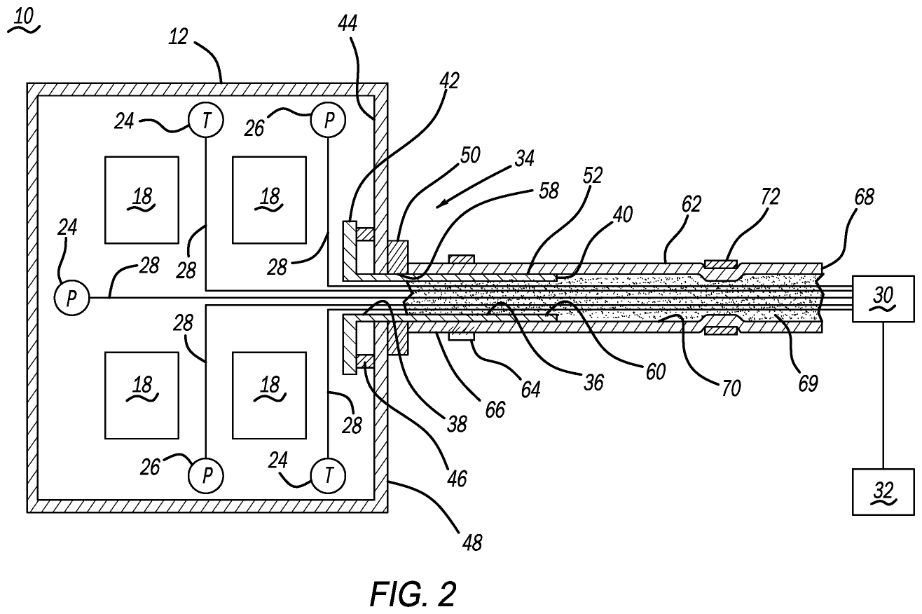

FIG. 1 illustrates an example battery pack 10 having a housing 12 including a base 14 and a cover 16 that are attached to each other in a hermetic manner. Housing 12 includes a plurality of battery cells 18 (FIG. 2). During operation of battery pack 10, the battery cells 18 may sometimes fail and undergo a process known as thermal runaway where the battery cells 18 release heat and/or gases that must be evacuated from the housing 12. Accordingly, housing 12 may include a plurality of discharge vents 20 having a one-way valve 22 positioned therein so that, upon a predetermined pressure threshold (e.g., 100 millibars) being reached within housing 12, the gases generated can be discharged from the housing 12 through the one-way valves 22 of the discharge vents 20.

Inasmuch as the battery cells 18 can sometimes fail and increase the temperature and/or pressure within the housing 12, it is becoming increasingly necessary to test how the housing 12 responds to increases in temperature and pressure before the housing 12 including the plurality of battery cells 18 is incorporated into a vehicle or some other structure where battery pack 10 is to be utilized. Put another way, it is becoming increasingly necessary to subject the housing 12 to thermal testing where the housing is subjected to at least increases in temperature as well as pressure testing where the housing 12 is subjected to at least increases in pressure. In order to monitor how the housing 12 responds to the changes in temperature and pressure, the housing 12 can be made to include various temperature sensors 24 and pressure sensors 26 (FIG. 2) that can generate signals indicative of temperature and pressure that are being experienced by housing 12.

As best shown in FIG. 2, a plurality of temperature sensors 24 and pressure sensors 26 may be positioned at various locations within housing 12. The locations of sensors 24 and 26 are for example purposes only, and it should be understood that the locations of sensors 24 and 26 are variable. In addition, while five sensors 24/26 are illustrated, it should be understood that a greater or lesser number of sensors 24/26 can be used so long as housing 12 includes at least one temperature sensor 24 and at least one pressure sensor 26 for use during the thermal and pressure testing of housing 12.

FIG. 2 also illustrates various locations where battery cells 18 may be positioned within housing 12. While only four battery cells 18 are illustrated, one skilled in the art will readily acknowledge and appreciate that battery pack 10 may include a greater or lesser number of battery cells 18 without departing from the scope of the present disclosure. Moreover, it should be understood that battery cells 18 may not necessarily be present in housing 12 during the thermal and pressure testing of housing 12.

In the illustrated embodiment, the sensors 24, 26 are each connected to a respective wire 28 that electrically connects sensors 24, 26 to a wiring bus bar device 30 that is configured to receive the signals indicative of temperature and pressure from the sensors 24, 26. While only a single bus bar device 30 is illustrated, it should be understood that each sensor 24, 26 may have a dedicated bus bar 30 if desired. In any event, bus bar 30 may subsequently communicate the signals received from sensors 24, 26 to a processing device such as, for example, a computer 32. Because sensors 24, 26 are connected to wires 28, the wires 28 must exit the housing 12 in order to be connected to bus bar device 30. Housing 12, therefore, may include an aperture 32 that permits wires 28 to exit housing 12. As shown in FIG. 1, aperture 32 may be formed in cover 16, but it should be understood that aperture 32 can also be formed in base 14 if desired.

Typically, after the wires 28 connected to sensors 24, 26 are passed through the aperture 32, the aperture 32 is sealed with a sealant that is permitted to cure before the thermal and pressure testing of housing 12 is conducted. Put another way, the sealant is necessary to ensure that housing 12 remains hermetically sealed during the testing. Unfortunately, such a configuration does not satisfactorily ensure that housing 12 remains sealed during testing because the changes in temperature and pressure experienced by housing 12 can cause the sealant to disengage from the aperture 32, which breaks the hermitic condition of the housing 12 and cause sensors 24, 26 to generate signals that are not indicative of the correct temperature and pressure.

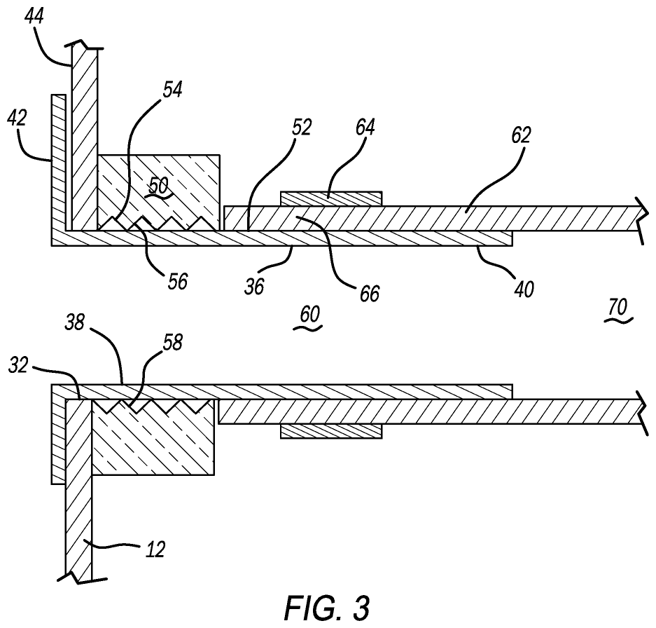

With the above in mind, the present disclosure provides a sealing structure 34 that maintains the housing 12 being hermetically sealed during the thermal and pressure testing of housing 12. Referring to FIG. 2, sealing structure 34 includes a hollow first pipe 36 that may be formed of a rigid material such as a metal material or a rigid polymeric material. First pipe 36 includes a first end 38 positioned within housing 12 and an opposite second end 40 that extends outward from housing 12. A radially outwardly extending flange 42 extends outward from first end 38 that is configured to abut against an interior surface 44 of housing 12 (FIG. 3). Alternatively, radially outwardly extending flange 42 is configured to abut against an annular gasket 46 positioned between flange 42 and interior surface 44. Gasket 46 may be formed of an elastomeric material such as rubber or some other type of polymer or monomer material that is configured to compress and create a seal between flange 42 and interior surface when first pipe 36 is rigidly secured to an exterior surface 48 of housing 12 using a nut 50. In this regard, an outer surface 52 of first pipe 36 may include a first threading 54 that is configured to mate with a second threading 56 formed at an inner surface 58 of nut 50.

First pipe 36 is hollow to permit wires 28 to pass therethrough and outward from housing 12. After or before first pipe 36 has been secured to housing 12 at aperture 32 using nut 50, wires 28 may be fed through a first passage 60 defined by first pipe 36. Regardless whether wires are fed through first passage 60 before or after first pipe 36 has been secured to housing 12, it may be necessary to secure first pipe 36 to housing 12 before feeding wires 28 through and attaching a hollow second pipe or hose 62 to second end 40 of first pipe 36. Second pipe 62 is preferably formed of a flexible material such as a flexible polymeric material and may be secured to first pipe 36 using a first clamp 64, which may be a metal or polymeric hose clamp that can be tightened and loosened as desired.

Second pipe 62 includes a proximate end 66 configured to be attached and secured to second end 40 of first pipe 36 using first clamp 64 and a distal end 68. A second passage 70 extends between proximate end 66 and distal end 68 that permits wires 28 to extend therethrough and outward from distal end 68 to be connected to bus bar 30.

After securing second pipe 62 to first pipe 36 using first clamp 64, a viscous sealant 69 is injected into second passage 70 from distal end 68. Sealant 69 may be formed of a material such as silicone, and is preferably formed of a material that can undergo room temperature vulcanization (RTV). While RTV materials are preferred, it should be understood that other types of materials for sealant 69 can also be used if desired. For example, sealant 69 may be formed of a material that is a viscous liquid that cures when exposed to heat.

An amount of sealant 69 injected into second passage 70 is sufficient to fill an entirety of second passage 70, and may also be sufficient to fill at least a portion of first passage 60 of first pipe 36. In any event, the important aspects to keep in mind are that wires 28 will be secured within first and second passages 60 and 70 upon curing (e.g., vulcanization) of sealant 69 and that the sealant 69 will hermetically seal housing 12. After injection of sealant 69 and maybe before sealant 69 has cured, a second clamp 72 may be attached to second pipe 62 to compress second pipe 62 in a radially inward direction such that a diameter of second passage 60 is narrowed at second clamp 72. In this manner, after sealant 69 has cured and housing 12 is subjected to thermal and pressure testing, the cured sealant 69 is restricted from moving within at least second passage 70. Thus, even if the pressure within housing 12 increases during the thermal and pressure testing, the sealant 69 will not disengage from housing 12 and hermetic sealing of housing 12 can be maintained. Accordingly, the signals indicative of temperature and pressure generated by sensors 24 and 26 during testing will not be negatively affected.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sealing structure for an aperture formed in a housing of a battery pack having at least one sensor positioned therein, the aperture configured to permit a wire attached to the at least one sensor to exit the housing, the sealing structure comprising:
a first pipe positioned in the aperture and including a first end, an opposite second end, and a first passage extending between the first end and the second end through which the wire extends from the housing, the first end having a radially outwardly extending flange configured to abut an interior surface of the housing;
a second pipe having a proximate end connected to the opposite second end of the first pipe, a distal end, and a second passage extending between the proximate end and the distal end through which the wire extends from the first passage;
a sealant provided in at least the second pipe that provides a hermetic seal of the aperture; and
a first clamp attached to the distal end of the second pipe in a manner that radially narrows a diameter of second pipe to restrict movement of the sealant to maintain the hermetic seal during increases in pressure of the housing.

2. The sealing structure according to claim 1, wherein the sealant is formed of a material that undergoes room temperature vulcanization.

3. The sealing structure according to claim 2, wherein the material includes a silicone material.

4. The sealing structure according to claim 1, further comprising an annular gasket between the radially outwardly extending flange and the interior surface of the housing.

5. The sealing structure according to claim 4, wherein the annular gasket is formed of an elastomeric material that is configured to be compressed between the radially outwardly extending flange and the interior surface of the housing.

6. The sealing structure according to claim 1, wherein an outer surface of the second end of the first pipe includes a threading.

7. The sealing structure according to claim 6, further comprising a threaded nut that is mated with the threading of the second end of the first pipe between an exterior surface of the housing and the proximate end of the second pipe.

8. The sealing structure according to claim 1, further comprising a second clamp that secures the proximate end of the second pipe to the opposite second end of the first pipe.

9. The sealing structure according to claim 1, wherein the second pipe is formed of a flexible polymeric material.

10. A method for sealing a wiring conduit attached to a battery pack, the method comprising:
passing a first pipe of the wiring conduit through an aperture formed in the battery pack;
fixing the first pipe to the battery pack;
attaching a second pipe of the wiring conduit to the first pipe;
injecting a viscous sealant into at least the second pipe attached to the first pipe;
attaching a clamp to the second pipe including the viscous sealant to radially narrow a diameter of the second pipe; and
curing the viscous sealant to hermetically seal the wiring conduit,
wherein the clamp that radially narrows the diameter of the second pipe restricts movement of the cured sealant to maintain the hermetic seal during increases in pressure of the battery pack.

11. The method according to claim 10, wherein the first pipe includes a radially outwardly extending flange configured to abut an interior surface of the housing, and the step of passing the first pipe of the wiring conduit through the aperture includes a step of placing an annular gasket between the radially outwardly extending flange and the interior surface.

12. The method according to claim 11, wherein the annular gasket is formed of an elastomeric material that is configured to be compressed between the radially outwardly extending flange and the interior surface of the housing.

13. The method according to claim 10, wherein the sealant is formed of a material that undergoes room temperature vulcanization.

14. The method according to claim 13, wherein the material includes a silicone material.

15. The method according to claim 10, wherein an outer surface of the first pipe includes a threading, and the step of fixing the first pipe to the battery pack includes mating a threaded nut with the threading of the first pipe.

16. The method according to claim 10, wherein the step of attaching the second pipe of the wiring conduit to the first pipe includes attaching a second clamp to the second pipe to secure the second pipe to the first pipe.

17. The method according to claim 10, wherein the second pipe is formed of a flexible polymeric material.
